(19) United States
(12) Patent Application Publication
(10) Pub. No.: US 2007/0009426 A1
(43) Pub. Date: Jan. 11, 2007

(54) Thermally coupled monolith reactor

(75) Inventor: Philip D. Leveson, Hannawa Falls, NY (US)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(73) Assignee: ZeroPoint Clean Technologies Inc.

(21) Appl. No.: 11/482,464

(22) Filed: Jul. 7, 2006

Related U.S. Application Data
(60) Provisional application No. 60/697,133, filed on Jul. 7, 2005.

(51) Int. Cl. B01J 8/02

(52) U.S. Cl. 423/659; 422/211

(57) ABSTRACT

The invention comprises, in one form thereof, a chemical processing method to thermally contact an endothermic and an exothermic reaction without mixing the two streams, utilizing a thermally coupled monolith reactor (TCMR). A ceramic or metal monolith is modified to produce a structure containing at least two sets of discrete flow paths and which are separated by a number of common walls. Manifolds are arranged such that one reaction mixture flows through one set of channels and a different reaction mixture flows through the second. Catalytic material, which is active for the relevant reaction, is coated onto the inner walls of each of the sets of channels. The two reactions are chosen such that one is exothermic and one is endothermic, such that the energy required by the endothermic process is supplied directly through the dividing wall from the exothermic process occurring on the opposing side. This method of heat transfer completely decouples the gas phase hydrodynamics from the heat transfer process.

### PRIORITY CLAIM

This application is based upon and claims priority to U.S. Provisional Patent Application No. 60/697,133, filed on Jul. 7, 2005, which is hereby incorporated by reference herein in its entirety.

### FIELD OF THE INVENTION

This invention relates to a chemical reactor and thermal processing apparatus.

### BACKGROUND OF THE INVENTION

Many chemical processes utilize catalysts to enhance chemical conversion behavior. A catalyst promotes the rate of chemical conversion but does not effect the energy transformations which occur during the reaction. A catalytic chemical reactor therefore must have a facility for energy to flow into or be withdrawn from the chemical process. Often catalytic processes are conducted within tubes which are packed with a suitable catalytic substance. The process gas flows within the tube and contacts the catalytic packing where reaction proceeds. The tube is placed within a hot environment such as a furnace such that the energy for the process can be supplied through the tube wall via conduction. The mechanism for heat transfer with this arrangement is rather tortuous as heat must first be transferred through the outer boundary layer of the tube, conducted through the often heavy gauge wall of the tube and then pass through the inner boundary layer into the process gas. The process gas is raised in temperature and this energy can be utilized by the process for chemical reaction.

The process engineer is often caused to compromise between the pressure drop within the tube reactor with the overall heat transfer and catalytic effectiveness. The inner heat transfer coefficient can be effectively increased by raising the superficial velocity of the process gas. The higher gas velocity therefore improves the thermal effectiveness of the system. However, higher gas velocities increase the system's pressure drop and results in increased compressor sizes and associated operating costs. A reactor must be of sufficient length to allow a reaction to proceed to the required conversion. Utilizing high gas velocities typically results in reactors with large length to width ratios which again results in systems with high pressure drops. The smaller the characteristic dimension of the catalyst particle the higher is the utilization of the catalyst. This is sometimes expressed as a higher effectiveness factor. However, beds formed from small particles exhibit higher pressure drops than similar beds formed from larger particle. So an engineer designs a system with expectable compromises between heat transfer, catalyst utilization, system conversion, and pressure drop. Therefore a reactor for conducting catalytic processes which can promote overall heat transfer and levels of conversion whilst minimizing pressure drop is desired.

Another deficiency of traditional heat transfer equipment is start-up time and thermal response to transients. As reactors are traditionally large and heavy they have significant thermal inertia. Therefore, the system takes significant time to re-equilibrate from any change in load or process operating conditions. Therefore a reactor with enhanced response characteristics particularly for rapid start up is desired in the art.

A number of US Patents have been directed to methods of increased heat transfer within reactors and towards low pressure drop catalytic reactors and processes. U.S. Pat. No. 6,759,016 issued to Sederquist, et al. describes a compact multiple tube steam reformer. The design consists of multiple packed tubes, of small diameter, being placed in intimate contact with a heat generating flame. The arrangement leads to improved heat transfer and therefore chemical conversion. However the packed tube results in a significant pressure drop and the author states the process is still heat transfer limited. Therefore a reactor design which minimizes the process side pressure drop and does not suffer from heat transfer limitation is required in the art.

U.S. Pa. No. 4,101,287 issued to Sweed, et al. describes a method to modify a monolithic structure into a combined heat exchanger reactor. The patent describes the mechanical process to transform the structure into a structure consisting of two discrete volumes. It is proposed that the arrangement can either be used as a heat exchanger, where energy is transferred from one stream to another via conduction through the wall or it is suitable as a chemical reactor where the second set of channels allow the introduction of a heat transfer fluid. In the second embodiment the energy required or generated through the reaction is removed via a heat transfer fluid in the second channel. It is noted that the reaction can be a catalytic process and the catalytically active material can be coated onto the monolith passage walls to minimize pressure drop. In this arrangement the heat transfer from the process catalyst to the dividing wall will be highly efficient, however, the uptake of the energy by the heat transfer fluid will suffer from all of the limitations of traditional heat transfer operations. In this case the boundary layer will provide a significant resistance to heat transfer and will severely limit the rate of the process. Also for this arrangement to successfully supply or remove heat and maintain a near isothermal longitudinal profile considerable heat transfer fluid velocities must be utilized. The high velocities will reduce the characteristic thickness of the boundary layer and ensure that a sufficient mass of heat transfer fluid is available to absorb the heat of reaction without significantly changing temperature. These requirements will lead to excessive pressure drop through the coolant channels. Therefore a reactor design which minimizes the heat transfer fluid side pressure drop is required in the art. Sweed does not teach about combining endothermic and exothermic reactions on opposing sides of dividing walls of adjacent channels as an efficient method of beat transfer.

U.S. Pat. No. 6,436,363 issued to Hwang, et al. describes a process to generate a hydrogen rich gas by generating a catalytic film which is composed of layers of different catalysts. It is proposed that steam reforming of a hydrocarbon be performed by one layer and the energy for this process be supplied by a hydrocarbon oxidative process being promoted in the subsequent layer. Various hybrids of this theme are proposed. However, as the heat is supplied by an autothermal reaction, oxygen must be supplied along with the fuel stream. As well as the oxygen, associated nitrogen is present. This nitrogen acts to absorb process energy which lowers the thermal efficiency of the process as well as diluting the desired product, hydrogen. The presence of the nitrogen increases the load on downstream partial oxidation units which act to oxidize carbon monoxide to carbon dioxide. The nitrogen also reduces the streams suitability for use in fuel cells. Therefore a reactor which can supply sufficient energy to an endothermic reaction without mixing the streams is needed.

U.S. Pat. No. 6,241,875 issued to Gough, describes a method where parallel and discrete channels can be formed by stacking suitable plates to form a structure. The plates are then bonded together using brazing, welding or diffusion bonding techniques. It is also claimed that cast ceramic plates can be used with a suitable sealing mechanism. Catalyst can be adhered onto the wall and energy supplied or removed via conduction between subsequent channels. However, the design does not allow for catalyst replenishment nor precious metal recovery. Therefore a reactor which affords an easy and cheap method for catalyst replacement and replenishment is required by the art.

U.S. Pat. No. 4,041,592 issued to Kelm teaches of methods which may be used to transform a monolithic structure into a cocurrent or countercurrent flow heat exchanger. The monolith is transformed by cutting or grinding the uppermost section of diving walls from rows of channels contained in the honeycomb. The top end of the newly formed groove is then sealed with suitable cement. The depth of the sealant is such that an opening still exists in the side wall of the structure. A manifold is attached to this inlet. A similar exercise is performed at the opposing end to produce an outlet section. Hot gas is passed through the inlet whilst cold coolant is passed through the open end. Efficient heat transfer occurs between the two streams. However, the possibility of using such an arrangement for coupling endothermic and exothermic catalytic processes on opposing sides of each dividing wall is not taught.

U.S. Pat. No. 4,214,867 issued to Hunter, et al. teaches of a method to efficiently transfer energy through a divider by contacting a catalyst to the wall and performing an exothermic reaction there. The energy is conducted through the wall and used to heat a gas stream on the opposing side of the wall. An apparatus is described where multiple layers are formed with alternating hot and cold channels to produce a gas heater. However, the patent does not discuss the possibility of utilizing this concept for thermally coupling endothermic and exothermic reactions within a monolith reactor.

U.S. Pat. No. 6,881,703 issued to Cutler, et al. teaches of a method to produce a thermally conductive honeycombs for chemical reactors. Cutler teaches a technique to produce an extruded metal monolith and highlights how copper or copper alloys are particularly suitable for this application. Cutler also teaches how catalysts may be attached to walls to produce an active catalyst matrix. It is claimed that thermally conductive monoliths reduce the likelihood of hot spot formation, as any hotter area conducts the energy via conduction through the monolith body to an area which is less hot. However, Cutler does not teach of the possibility of having different chemical reactions simultaneously occurring on opposing sides of the monolith substrate.

One embodiment of the current invention provides an improved chemical processor which is suitable for efficiently carrying out chemical reactions.

Another embodiment of this invention provides a reactor which can be ready produced by suitable modification of a regular monolithic structure such that two reactions of different energetic nature can be catalytically performed on opposing sides of walls which divide the two sets of discrete flow channels.

This invention may also provide a reactor where the catalytically active components are immobilized on adjacent sides of the monolith dividing walls such that heat transfer can occur via purely conduction through the wall from one catalytic process to the second catalytic process.

This invention may also provide a reactor where the monolith body is demountable from the inlet and outlet manifolds such that catalyst replacement and recovery of spent catalyst can be easily performed.

Certain embodiments of this invention may provide a reactor where the heat transfer characteristics are decoupled from the reactant or product fluid velocities such that the system can operate with moderate gas velocities and with low pressure drops.

This invention may also provide a reactor of low thermal inertia and high heat load such that rapid start up and fast response to load transients can be achieved.

### SUMMARY OF THE INVENTION

The invention comprises, in one form thereof, a chemical processing method to thermally contact an endothermic and an exothermic reaction without mixing the two streams, utilizing a thermally coupled monolith reactor (TCMR). A ceramic or metal monolith is modified to produce a structure containing at least two sets of discrete flow channels and which are separated by a number of common walls. Manifolds are arranged such that one reaction mixture flows through one set of channels and a different reaction mixture flows through the second. Catalytic material, which is active for the relevant reaction, is coated onto the inner walls of each of the sets of channels. The two reactions are chosen such that one is exothermic and one is endothermic, such that the energy required by the endothermic process is supplied directly through the dividing wall from the exothermic process occurring on the opposing side. This method of heat transfer completely decouples the gas phase hydrodynamics from the heat transfer process.

More particularly, the invention comprises, in one form thereof, a monolith to which, at each end, the uppermost section of the dividing walls of alternate rows of channels has been ground or cut away. The top section of each of the created voids has been sealed with a suitable material from the end to a depth as to leave an opening in the outer wall, such that a distinct inlet or outlet is formed. A catalyst coating has been applied to the inner wall of the two sets of channels using a suitable technique, one of which is the well known washcoat technique. Two manifolds, with suitable gaskets, are attached to open ends of the monolith. Furthermore two addition manifolds, with suitable gaskets, are affixed to the two newly formed openings. The gasket material is chosen to afford a reasonable gas tight seal to prevent cross flow between the two channels. The catalyst coatings may need to be calcined and reduced as is common to people skilled in the art in order to produce an active catalyst.

More particularly, the invention comprises, in one form, a monolith to which alternate channels have been sealed at opposing ends. A catalyst coating has been applied to the inner wall. A thin capillary like tube is passed through the inlet of the void and arranged such that it falls short of the sealed end. The opposing end is prepared in a similar manner. Process gas is passed through this tube to the far end of the monolith. The fluid exits the tube is directed back towards to inlet. As the fluid traverses the channel reaction occurs in the catalytically coated walls. Any heat which is required or generated by the process is transferred through the wall. However, even with this highly efficient transfer mechanism the gas will still absorb some heat energy and become hot. This heat energy can be conducted through the capillary inlet tube to preheat the incoming reactants. This arrangement alleviates the need for an external heat exchanger (although one can be used to provide further heating) and improvers the overall efficiency of the reactor.

In one form, the invention includes a monolithic catalytic reactor with a primary flow path comprising a number of tubes which are lined with a catalyst. As chemical reactants are fed into the primary flow path the chemicals react, with the aid of the catalyst, to produce an exothermic reaction. In the same catalytic reactor is a secondary flow path, also comprising a number of tubes and also lined with a catalyst. In this secondary flow path, a different collection of chemical reactants are fed and, through the aid of the catalyst, will produce an endothermic reaction. The tubes of the primary and secondary flow paths are interspersed with one another within the monolith such that the heat generated from the exothermic reaction may conduct through the tube walls and serve as a heat source for the endothermic reaction.

Furthermore, the invention includes a method for enhancing one or more catalytic chemical reactions in terms of rate, product yield, energy and other parameters. Here, the initiating an exothermic reaction within one flow path of the monolithic reactor serves the dual purpose of creating a product yield as a result of that exothermic reaction and as a heat source. With the aid of this heat source, a second and endothermic reaction may be initiated in a secondary flow path which may absorb the heat from the exothermic reaction thereby enhancing product yield and making efficient use of available energy. To optimize the use of this heat, the reactions are controlled through one of many factors such as feed rate of the reactants, catalyst quality, reactant concentration and others. The flow paths may be cocurrent, countercurrent or other such variation as necessary to maximize heat transfer between the two reactions.

### BRIEF DESCRIPTION OF THE DRAWINGS

The above-mentioned and other features and advantages of this invention, and the manner of attaining them, will become apparent and be better understood by reference to the following description of several embodiments of the invention in conjunction with the accompanying drawings, wherein:

FIG. 1 is a cross-sectional schematic of a thermally coupled monolith reactor of the present invention;

FIG. 2A is an end view of the monolith body of FIG. 1;

FIG. 2B is an isometric view of the monolith body of FIG. 1;

FIG. 2C is an end view of the monolith body of FIG. 1 having the sealant in place;

FIG. 2D is a plan view of the monolith body and sealant of FIG. 2C;

FIG. 2E is an isometric view of an alternative monolith body to that of FIG. 2B;

FIG. 2F is a plan view of an alternative monolith body with sealant according to the present invention;

FIGS. 3A-3C are end views of a monolith structure having alternative flow path arrangements according to the present invention; and

FIG. 4 is a cross-sectional schematic of an alternative embodiment of a thermally coupled monolith reactor with an integral reactant pre heater according to the present invention.

Corresponding reference characters indicate corresponding parts throughout the several views. The examples set out herein illustrate several embodiment of the invention but should not be construed as limiting the scope of the invention in any manner.

### DETAILED DESCRIPTION

The invention relates to a thermally coupled monolith reactor (TCMR), used to thermally contact endothermic and exothermic reaction streams in adjacent channels. The geometry allows intimate thermal contact whilst keeping the streams from becoming mixed. The reactor body is constructed by modification of a substantially rigid and essentially nonporous monolith honeycomb. Prior to modification the monolith consists of a honeycombed body having a matrix of thin walls defining a multiplicity of discrete channels which pass through the body of the structure from one face to the opposing face. The monolith is modified in such a way as to produce a rigid body containing at least two discreet process flow paths which have a number of dividing walls in common. For the purpose of this invention, a channel is defined as any individual passageway through the monolith body and a flow path is the group of channels used for a single reaction.

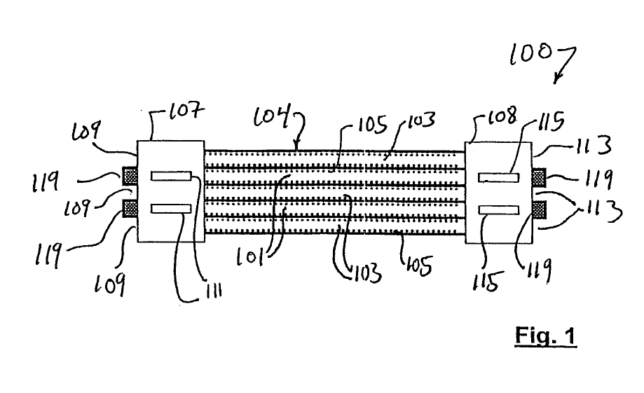

In FIG. 1, a cross section of a TCMR 100 having five flow paths is illustrated. It can be seen that two discrete flow paths 101 exist for a first reaction between a first set of reactants and three discrete flow paths 103 exist for a second reaction between a second set of reactants. These flow paths 101 and 103 have been formed through suitable channel subdivision of a monolith structure 104. A suitable catalyst 105 is coated onto the inner wall of both reaction volumes. Different catalysts may be used for the different reactions. An inlet manifold 107 and an outlet manifold 108, are attached to allow introduction and expulsion of the process reactants. In this embodiment, the inlets 109 to the first reaction flow paths 101 and the inlets 111 to the second reaction flow paths 103 are in the inlet manifold 107 such that the reactants run in a cocurrent configuration. The reactants also leave the reactor 100 in the same outlet manifold 108 via the first reaction outlets 113 and the second reaction outlets 115. The fuel processor is described using the steam reformation of methane and oxidation of methane reactions in Example 1 to illustrate the concept. In an alternative embodiment, the inlets and outlets are arranged for a countercurrent flow of the reactants.

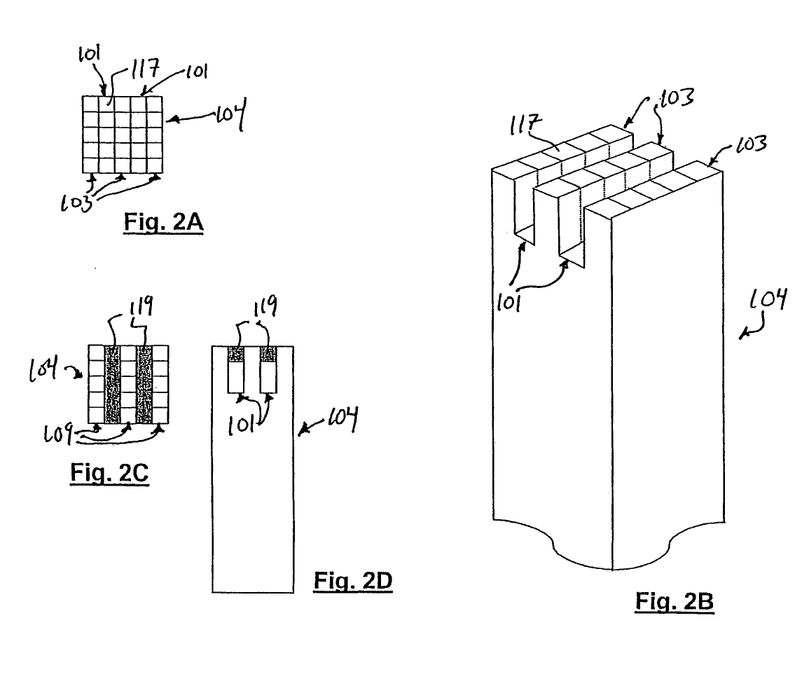

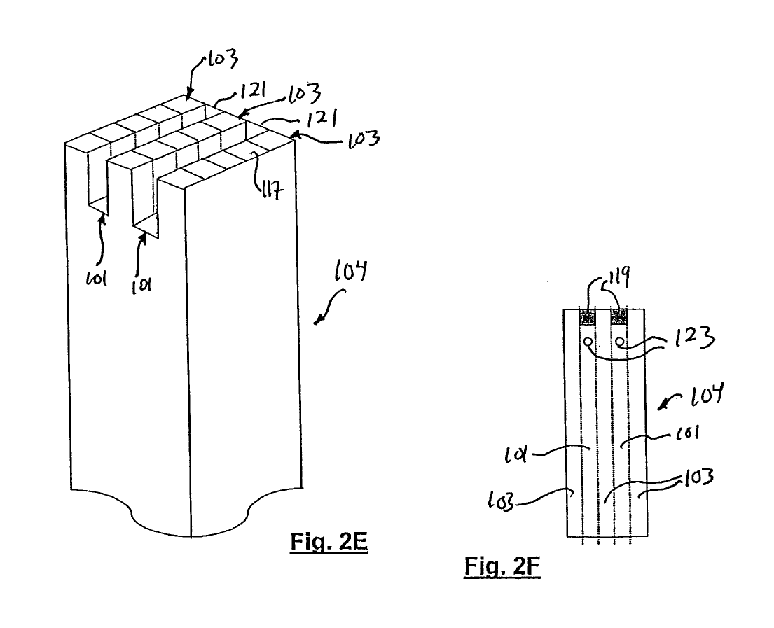

The method of constructing the segregated monolith 104 according to the present embodiment is shown in FIGS. 2A-2E. FIG. 2A illustrates the monolith 104 having a square cross-section and including 25 similar channels 117 arranged in a 5 by 5 grid. The grid illustrated in the figures is by way of example and grids of any dimension may be used. The channels 117 form the flow paths 101 and 103. The square cross-section of the channels 117 is used for the large amount of shared surface area for heat transfer between adjacent channels 117. Cross-sectional shapes such as hexagons, triangles, and circles may be used in alternative embodiments. FIG. 2B shows the same monolith 104 with the dividing walls of a portion of the flow paths 101 removed. These dividing walls are removed to sufficient depth that an end seal 119, shown in FIGS. 2C and 2D, and suitable manifold 107 or 108 (FIG. 1) can be attached to the body 104. This depth is typically in the range of about 0.25 inches to about 2 inches according to the present embodiment. FIGS. 2C and 2D show the monolith 104 with suitable sealant 119 applied to the ends of the flow paths 101. A number of sealants are suitable, however, the sealant should be capable of withstanding the operating temperature of the reactor and be essentially nonporous. For high temperature applications, the sealant of the present embodiment has a similar coefficient of expansion as the monolith material to avoid excessive stresses on the structure.

FIG. 2E shows a similar manipulation as that shown in FIG. 2B, except the far outer wall 121 is left intact such that the manifold 107 or 108 is attached to only one face of the body 104. FIG. 2F illustrates a further alternative arrangement having a single hole 123 drilled through the side wall of the monolith 104 to connect a row of parallel channels 117 in each of the flow paths 101. One hole 123 for each flow path 101 is shown in the figures, however, it is possible to drill many holes 123, each at a slightly different longitudinal location. The multiple holes 123 may be interconnected to form a slot. Such an arrangement will minimize radial pressure differences and ensure even reactant distribution through each channel 117.

All of the above described mechanical manipulations can be performed using standard engineering operations such as grinding, cutting, milling and machining. It is also possible to use more sophisticated techniques such as laser cutting. The engineering modifications can be made after the monolith 104 has been cast and not fired, i.e. in its green state, or after the monolith 104 has been fired. If a cement is used to seal the channels 117, the monolith 104 and cement can be fired at the same time. The channels 117 may also be sealed with a suitable end plate to seal multiple channels with one piece or the insertion and sealing of individual channel plugs.

The monolith body may be constructed from a number of materials using a range of techniques. Suitable materials include ceramics with a low coefficient of thermal expansion which are readily extrudable. These include, but are not limited to, mullite, corderite, alumina, and silica. Other materials include metals which may be extruded, welded, brazed, or diffusion bonded to make such structures. Using metals, it is sometimes useful to start with metal oxide powders, which are then bonded and reduced to the metallic state. Suitable metals include copper, aluminium, stainless steel, iron, titanium, and mixtures or alloys thereof.

The dividing walls of the TCMR 100 must be of sufficient strength to maintain the integrity of channels 117. The minimum wall thickness therefore depends upon material of construction. In the present embodiment, the wall thickness is in the range of about 0.5 millimeter to 5 millimeters and more particularly in the range of about 0.5 millimeter to 2 millimeters. The wall will act as a thermal barrier to heat transfer, however, as the wall is very thin its resistance is small. For example the thermal conductivity of dense corderite is around 2 W/mK. If the wall is 1 millimeter thick, then the heat transfer coefficient can be calculated by Equation 1:
U=k/x (1)
Where U is the heat transfer coefficient (W/m²K), k is the thermal conductivity of the material (W/mK) and x is the thickness of the material (m). In this case, the thermal resistance offered by the dividing wall equates to 2kW/m²K. Thus the two channels will operate with a similar operating temperature. Even for a highly energetic process requiring 20kW/m², the driving force for the flow of energy will be less than 10° C.

### EXAMPLE 1

In this example, reaction 1 is the steam reforming of methane, expressed by Equation 2:
CH₄+H₂O⇄CO+3H₂ ΔH_{f}=206 kJ/mol (2)
This fast and energetic process requires that a significant amount of energy be supplied to the catalyst to prevent the process from becoming thermally limited. This heat is to be supplied by reaction 2, which, in this example, is the catalytic oxidation of methane, expressed by Equation 3:
CH₄+O₂→CO₂+H₂O ΔH_{f}=−800 kJ/mol (3)
Approximately 0.25 mol of methane is combusted for each mol of methane processed. The overall process consists of first preheating the reactants to the required temperature. It ensures good thermal management for the products leaving the reactor to be used to preheat the incoming reactants to a temperature close to the reaction temperature. The methane, oxygen, and associated nitrogen (reaction 2) flow through the inlets 109 of the inlet manifold 107 and into the reaction channels 117 of the flow path 103. Heterogeneous oxidation occurs in the catalyst 105 attached to the wall. As the stream flows down through the flow path 103, the conversion increases until the stream passes through the outlets 113. In the adjacent flow paths 101, preheated methane and steam enter the second discrete set of channels 117 through inlets 111, contact the catalyst 105 coated onto the wall, and reaction occurs. The heat for the reaction is supplied directly through the wall from the oxidation channels occurring on the opposing side of the dividing wall. As the heat transfer characteristics are highly independent of the bulk reactants velocity, a velocity can be chosen to ensure that the reactants exiting the reactor has attained the desired level of conversion or indeed reached any equilibrium. It is interesting to note that in such an arrangement it is desirable to operate the reactants in a cocurrent flow arrangement. This ensures that the area with the greatest heat generation is adjacent to the area with the greatest heat requirement. However cases may exist where a countercurrent flow arrangement is desirable.

The system can be used to for a number of reactions as a wide range of process conditions are possible. According to the current embodiment, the reactor can be used in the temperature from ambient to about 1200° C. and with pressures up to about 3000 PSI.

It is inevitable that the catalyst coating 105 will eventually deactivate to the point where economics drive for its replacement. It is sometimes possible to extend a catalyst life and reclaim some activity by techniques such as hydrogen treatment or methods to remove carbon buildup. These techniques can be readily applied to the TCMR 100. The reactor 100 also allows the body 104 to be removed and monolith replacement performed. This is simply achieved by removing the relevant inlet manifold 107 and outlet manifold 108 and removing any monolith supports or containment structure. A new monolith 104 can be inserted and reverse procedure applied. If the endothermic catalyst requires high temperature hydrogen activation, the heat can be supplied via the exothermic channels. The spent monolith 104 can be recycled after recovery of any of the precious metal components of the catalyst 105.

A number of techniques are available in which to deposit an active catalyst 105 onto the wall of the monolith 104. One such technique is that of the washcoat as is used in catalytic converters. Others include the sol-gel technique, metal sputtering, or the grinding of commercial catalyst pellets followed by attachment through the use of a cement or sol-gel. Many of the coating techniques allow different thicknesses of coating to be applied. It may also be possible to increase or decrease the thickness of the coating along the channel length. This technique can be used enhance the kinetics in the downstream sections of the channel. The thickness of the catalyst coating depends upon the process proceeding within the catalyst matrix. The products of some processes, such as the Fischer Tropsch synthesis, are highly dependent upon the catalyst thickness. In this case, the thickness should be no larger than the characteristic length beyond which the product spectrum degrades. For some processes the catalyst thickness has no effect on the product spectrum, an example of which is the steam reforming of methane. In this case the catalyst thicknesses can be of any dimension. However, excessively thick coatings are avoided in the present embodiment as the catalyst interior performs little reaction due to diffusion limitations and acts as a thermal barrier.

Many catalysts are prone to deactivation due to diffusion of an impurity into the catalyst. In cases where the catalyst is supported on a metallic surface, the source of the impurity is often the metal surface itself. Metals have low diffusion coefficients, however, as the catalyst is in intimate contact with the support over extended periods and at elevated temperature, small amounts of the metallic substrate will diffuse into the catalyst structure. A common example of this effect is the poisoning of nickel based steam reforming catalysts with iron. It is possible to minimize this effect by using a dense and nonporous barrier coating located between the metal surfaces and the active catalyst. However, this problem can be circumnavigated through the use of ceramic structures as is used in the current embodiment.

An advantage of the arrangement shown in FIGS. 1 and 2A-2F is the low thermal inertia of the system. This allows the reactor 100 to operate with inherently fast thermal response and is particularly advantageous during startup. The low thermal inertia will minimize startup time to the order of minutes from the order of hours, which is typical for large packed tube technology. With suitable ancillary equipment, the system can be operated with a level of control and operating flexibility not encountered in traditional steam reformers.

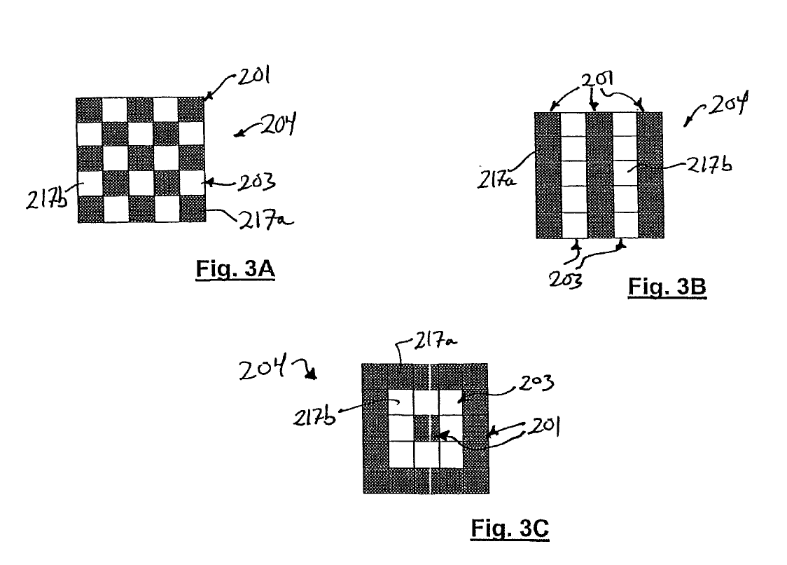

FIGS. 3A-3C show alternative topological arrangements of providing heat transfer surfaces between the two flow paths 201 and 203 of a monolith body 204. In the figures, the crosshatched channels 217a are associated with the flow paths 201 for the first reaction and the remaining channels 217b are associated with the flow paths 203 for the second reaction. It is useful to maximize the surface area of the sidewalls that channels 217a and 217b share in common for optimal beat transfer. Suitable geometries in addition to those in the first embodiment include a checker board configuration shown in FIG. 3A, an alternating row configuration shown in FIG. 3B, or a concentric channel configuration shown in FIG. 3C.

The examples used herein all consist of a square monolith 204 constructed from square channels 217a and 217b. Although this simple geometry has been used to illustrate the concept, a number of other geometries relating both to the outer monolith shape 204 and to individual topologies of the channels 217a and 217b are possible. Such tessellations include but are not limited to squares, rectangles, triangles, circles and hexagons. Also, the examples chosen here produce a monolith 204 containing two discrete flow paths 201 and 203, but it is possible to adapt the technique to produce a structure containing more than two discrete flow paths, each capable of performing a different chemical reaction.

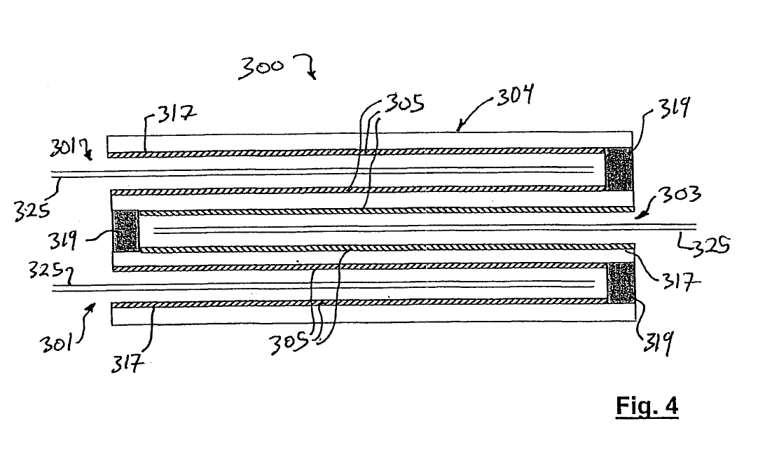

A further embodiment of this invention is illustrated in FIG. 4. The TCMR 300 does not require the monolith 304 be cut in any way and allows more complicated channel 317 arrangements to be used. All of the flow paths 301 for the first reaction are sealed using a suitable cement or other sealant 319. The sealant 319 is applied to a depth such that the seal is substantially leak-free. Next, the monolith 304 is turned around to expose the opposing end. The end of the flow paths 303 in which the second reaction will occur are sealed using a similar technique. Thus, a monolith 304 in which every flow path 301 and 303 is sealed at just one end is produced. Feed delivery pipes 325 are placed within each channel 317 such that all of the feed pipes 325 for each reaction enter the monolith 304 from the same end. These feed pipes 325 can then be connected to a suitable manifolding system so as to supply approximately the same amount of reactants to each channel 317. The feed tubes in this arrangement act as a countercurrent flow heat exchanger thus preheating the reactants to temperature prior to contacting the catalyst 305. This arrangement improves the overall thermal efficiency of the system. It is also possible to utilize external preheating if further energy input is required. The feed tubes 325 must be small enough in diameter to pass into the channel 317 and have an inner diameter of size to produce an acceptable pressure drop. If all of the feed tubes 325 pass to a common feed distributor, this pressure drop will ensure an even feed delivery to each channel 317. One layer with one channel 317 for flow path 303 and two channels for flow path 301 is shown in FIG. 4, however, multiple layers similar to the one shown are formed in the monolith body 304. In alternating layers, two channels for flow path 303 and one channel for flow path 301 may be provided to form a checkerboard end view of the monolith body 304 similar to that shown in FIG. 3A.

It should be noted that an advantage of the invention is the ability to use low calorific fuel for the exothermic reaction. Such fuel is not ideally suited to homogeneous combustion and results in a highly unstable flame. Heterogeneous combustion aids in spreading the heat generation along the length of the channel and helps prevent hotspot formation. The use of low caloric value gas allows the use of certain waste streams as the fuel to supply the heat. Examples of such streams include the off-gas stream from a fuel cell, the gaseous components from a FT synthesis, and the stream remaining after hydrogen removal from a membrane gas shift reactor.

It should be further noted that the heat generation rate per unit area is approximately matched to the heat requirement in the adjacent channel. This can be achieved by controlling the catalyst thickness in each channel. A trial and error process may be required to obtain the optimum catalyst thicknesses for some processes. If the processes are not thermally matched, the overall efficiency of the reactor will be reduced.

The hydraulic diameter of a non circular channel can be calculated using Equation 4:
D_{hyd}=(4*A_{C}/P) (4)
Where A_{C} is the cross-sectional area of a channel and P is the length of the perimeter of the channel. In one embodiment, D_{hyd} is in the range of about 0.5 millimeter to about 5 millimeters. When using large channels it is possible that the reaction will become diffusion limited, such that the rate of reaction is dictated by the rate at which unreacted molecules can diffuse from the center of the channel into the catalyst matrix. In this case it is possible to add flow disturbance elements in the channel or emanating from the wall. These elements will produce a degree of convective mixing by forming local flow disturbances in an otherwise laminar environment. If a heat transfer fluid is used to remove the heat of reaction from a reaction occurring in any adjacent channel, then these flow disturbance elements would provide a useful and low pressure drop method of enhancing thermal performance.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed as the best mode contemplated for carrying out this invention, but that the invention will include all embodiments falling within the scope and spirit of the appended claims.

1. A multiple flow path monolithic catalytic reactor comprising
a) a monolith body having a plurality of discrete channels formed therethrough;
b) a primary flow path comprising a first plurality of said channels being lined with a primary catalyst, which enables an exothermic chemical reaction;
c) a secondary flow path comprising a second plurality of said channels being lined with a secondary catalyst, which enables an endothermic chemical reaction; and
d) wherein said primary flow path and said secondary flow path are arranged to allow heat transfer therebetween.

2. The reactor of claim 1, wherein a plurality of reactants are preheated by a separate heat source.

3. The reactor of claim 1, wherein a first plurality of reactants are preheated via an integrated pre-heater, which comprises a capillary tube within each of said channels.

4. The reactor of claim 1, wherein each of the first plurality of said channels share a common heat transfer surface with at least one of the second plurality of said channels.

5. The reactor of claim 4, wherein said heat transfer surface has a wall thickness in the range of about 0.5-mm to about 5-mm.

6. The reactor of claim 1, wherein said channels have a shape selected from the group consisting of squares, rectangles, triangles, circles, and hexagons.

7. The reactor of claim 1, wherein said monolith body is removable from said reactor,

8. The reactor of claim 1, wherein said primary and secondary flow paths are cocurrent.

9. The reactor of claim 1, wherein said primary and secondary flow paths are countercurrent.

10. The reactor of claim 1, wherein said primary and secondary flow paths are perpendicular.

11. A method of enhancing a catalytic chemical reaction in a monolithic reactor, comprising the steps of:
a) providing a first flow path having a catalyst layer for an exothermic chemical reaction;
b) providing a second flow path having a catalyst layer for an endothermic chemical reaction, wherein the second flow path is in proximity to the first flow path; and
c) controlling a reaction parameter to provide an optimal level of beat transfer between the endothermic and exothermic reactions for reaction efficiency.

12. The method of claim 11, wherein said reaction parameter is controlled manually.

13. The method of claim 11, wherein said reaction parameter is controlled automatically.

14. The method of claim 11, further comprising the step of preheating the reactants.

15. The method of claim 14, wherein said reactants are preheated through the use of said exothermic reaction.

16. The method of claim 11, wherein the reaction parameter in said controlling step is selected from the group consisting of the amount of catalyst applied to said first and second flow paths, the flow rate a reactant, and the molar ratio of a first reactant to a second reactant.

17. The method of claim 11, further comprising the step of periodically removing said first and second flow paths to replenish said catalysts.
